(19) United States
(12) Patent Application Publication
(10) Pub. No.: US 2007/0269775 A1
(43) Pub. Date: Nov. 22, 2007

(54) Personalized system and method for teaching a foreign language

(75) Inventors: Alexei Andreev, Palo Alto, CA (US); Stephan Brackertz, Frankfurt (DE); Olga Beregovaya, San Francisco, CA (US); Slava Kritov, Palo Alto, CA (US)

Correspondence Address: HOUSTON ELISEEVA, 4 MILITIA DRIVE, SUITE 4, LEXINGTON, MA, 02421, US

(73) Assignee: Dreams of Babylon, Inc., Palo Alto, CA (US)

(21) Appl. No.: 11/226,078

(22) Filed: Sep. 14, 2005

Related U.S. Application Data
(60) Provisional application No. 60/609,468, filed on Sep. 14, 2004.

(51) Int. Cl. G09B 19/00

(52) U.S. Cl. 434/156

(57) ABSTRACT

In one aspect, the invention is directed to an interactive method for teaching a foreign language. The method includes displaying a translation of a target word selected by a user from a reading material, testing the user's assimilation of the target word, evaluating results of the testing to obtain an evaluation outcome; and adding the target word to an active vocabulary associated with the user or retaining the target word as unassimilated, depending on the evaluation outcome. Testing can be based on recognition or reproduction techniques. In preferred examples, the method further includes providing the reading material. In another aspect, the invention is related to a system for teaching a foreign language, the system including a link for requesting and receiving translation of a word from a global vocabulary and a module capable of generating drill exercises for prompting assimilation of the word.

### RELATED APPLICATIONS

This application claims the benefit of U.S. Provisional Application No. 60/609,468, filed on Sep. 14, 2004, which is incorporated herein by reference in its entirety.

### BACKGROUND OF THE INVENTION

Most existing techniques for learning foreign languages combine several activities, such as reading comprehension training, practice of grammar structures, and vocabulary building drills. While these approaches vary in the details, it is commonly accepted that the knowledge of foreign words and the ability to understand written text comprise major cornerstones of foreign language proficiency. Therefore, mastery of active and passive vocabularies is highly critical for any foreign language learner, from beginners to advanced and proficient students.

Existing methods for vocabulary learning generally are based on memorization of foreign words together with their translation, definition, and contextual usage. For instance, the Berlitz method employs text excerpts or foreign language books to illustrate contextual usage, supplied by a set of questions to facilitate keyword memorization.

Another approach often employed to facilitate memorizing new words is based on “flash-card” exercises. In some instances, flash card drills are grouped into lessons. In others instances, they are presented in an unstructured collection of words with translations that represent a set of topics.

A further method employed for word memorization is based on “fill in the blank” exercises to facilitate active use of newly acquired words.

Existing methods for learning foreign languages present several problems.

One of the problems is related to materials employed in teaching a foreign language. In many cases, the materials lack excitement, real-life context and/or an up-to-date appeal. Often, teachers, professors and textbook authors design a curriculum of texts that is rarely updated over the years due to the effort involved with change. The use of obsolete reading materials or of texts that have minimal relevance to a student's day-to-day interests prevents full engagement, fosters boredom and can seriously impede learning and progress.

Even when updated, materials generally are designed for a broad audience and do not target the needs or interests of a particular individual. This problem is exacerbated for those who wish to master colloquial language, idioms or a specialized dictionary in a specific field.

Often, existing methods do not address language changes and lag behind with respect to neologisms that are constantly being introduced into a language. As languages evolve over time, dictionaries, frequency of word usage, word patterns and meanings evolve. New words are added to a language and may belong to a professional language that is used in a specialized industry and therefore “is not a common language” that might be found in dictionaries. New words also may be acquired from other languages or they may relate to names of now-important geographic locations, sportive events, public figures, etc.

Old reading materials do not reflect these language changes and students end up learning an outdated version of the foreign language.

Again, the problem is exacerbated for those who wish to build vocabularies in specialized disciplines, since specialized words often are not included in traditional or technical dictionaries. For instance, many cricket, soccer, meteorology or anesthesiology terms are not normally found in existing dictionaries or training courses and international dictionaries for automotive logistics exist only incompletely. Thus if a student wants to become proficient in a particular area or discipline, he or she encounters many obstacles in building, maintaining and memorizing a highly-customized dictionary.

A further problem associated with conventional methods of learning a foreign language relate to the absence of individualized correlations between training materials, e.g., textbooks, and individual proficiency level. Frustration with the new language can stem not only from uninteresting topics but also from an abundance of unknown words in a reading material. The general belief is that the most efficient learning process takes place when the percentage of unknown words in the text does not exceed 25%. Otherwise, the foreign language learners experience frustration from being unable to perceive the underlying textual material as a whole (in order to put together a cohesive story) without checking their dictionaries too often.

Existing methods attempt to interpolate the proficiency in a foreign language by categorizing people into relatively large subgroups, such as first year Spanish, 3rd year Japanese, etc. Such grouping is far from adequate in addressing individual needs and these broad categories do not accommodate an individual's proficiency in the foreign language.

The current paradigm of “one-size-fits-all” reading does not deliver individually tailored complexity levels designed to track the changes in active and passive vocabularies over time. This problem is particularly serious in the case of students who have a breakdown in the learning process, for example caused by illness. A well-known motto “if you do not use it, you will lose it” is fully appropriate here, and if a student who did not practice the foreign language for a period of time cannot get back to the same text, e.g., article, as others in the same sub-group, there is no room for readjusting the student's progress within the existing “one-size-fits-all” paradigm.

There are many students who studied a foreign language and could speak it well at one time, yet years later, due to lack of practice, can barely understand it and are upset and frustrated that they cannot do more with the language. Existing methods cannot bring such a student “back in time” by letting him review those words he once knew. Even though the nerve connections for this information already exist in the brain (dormant if you will), existing methods cannot specifically activate them to bring back that knowledge. Nor can existing methods provide such a review in contexts that are new and interesting.

Conventional techniques, therefore, do not track students' progress and do not remember where they are in their language proficiency. They cannot help refresh foreign language skills for those who had a break in their language studies. Reviewing material previously learned may take a lot less effort than learning something new. However, current methods for learning another language are not capable of tracking the specific history of a student's learning process and cannot differentiate between what a particular student once knew and what she did not know.

Human-to-human interaction is a very important part of learning experience. It creates competitive environment, milestones and an opportunity to practice and test language knowledge on peers. Unlike students who learn foreign languages in classes, individual language learners often lack an opportunity to discuss texts or practice two-way communications even if they have identical textbooks or reading materials. The lack of language learning-related communications (interactive or sequential) negatively impacts their interest in the subject, causing deterioration of the learning experience thus harming the training results. The lack of collaboration impedes the efficiency of individual learners, pushing them to join various language classes to enrich their experience.

Even then, interaction may not be possible all the time, for everyone, due to peoples' schedule or geographic constrains. For example, a learner of Xhosa can hardly sign up for a class if he or she lives away from major universities in US. It might be totally impossible in some countries where the Zulu expertise is not present.

Therefore, a need exists for an approach to the study of foreign languages, which reduces or minimizes the above-mentioned problems. For example, a need exists for an educational method and system in which the foreign-language lessons are tailored to the individual in a way that is not a crude approximation of their skill level. A need also exists for a method and system that address personal interests and requirements, with targeted reading materials and customized language drilling exercises. A need also exists for a method and system that incorporate materials and dictionaries that are up-to-date and/or specific to particular areas or disciplines. Furthermore, there is a need for a language learning method and system that provide collaboration capabilities for individual learners separated geographically.

### SUMMARY OF THE INVENTION

The invention generally relates to teaching, or from a user's point of view, of learning a foreign language.

In one aspect, the invention is directed to an interactive method for teaching a foreign language. The method includes displaying a translation of a target word selected by a user from a reading material, testing the user's assimilation of the target word, evaluating results of the testing to obtain an evaluation outcome, e.g., a measurement of the user's understanding. The target word is added to an active vocabulary associated with the user or is retained as unassimilated, depending on the evaluation outcome. Testing can be based on recognition or reproduction techniques. In preferred aspects, the method further includes providing the reading material.

Reading materials can be customized to a student's level of proficiency in a foreign language by a method which includes obtaining a collection of reading materials in the foreign language, comparing the words in each reading material with a student's vocabulary in the foreign language, to obtain an overlap between each reading material and the student's vocabulary, and ranking each reading material according to the overlap. A higher overlap between the student's vocabulary and the reading material is indicative of a lower customized ranking in difficulty assigned to the reading material.

In another aspect, the invention is directed to a method for maintaining or increasing the user's proficiency in a foreign language. The method includes storing the user's overall vocabulary is the foreign language, monitoring the user's usage or recognition of words in the user's vocabulary to determine the user's active vocabulary and the user's passive vocabulary, presenting the user with drill exercises for words in the user's passive vocabulary, thereby prompting the user to re-assimilate the words in the user's passive vocabulary and transferring re-assimilated words to the user's active vocabulary.

In specific examples, the invention is directed to an interactive method for increasing a vocabulary in a foreign language. The method includes reading a text in the foreign language, requesting a translation of an unknown word found in the text and responding to flash card exercises designed to prompt assimilation of the unknown word into the vocabulary. Preferably the reading material is customized with respect to the user's level of proficiency.

The invention also is directed to a system for teaching a foreign language. In one embodiment, the system includes a collection of reading materials in the foreign language, a link for a user's selection of a reading material from the collection, an interface for requesting and receiving a translation of a word in the reading material, a module for generating at least one drill exercise to prompt assimilation of the word by the user and a module for adding an assimilated word to an active vocabulary associated with the user.

In a further embodiment, the invention is directed to a system for increasing a user's reading comprehension in a foreign language. The system includes an article in the foreign language, a stemming unit for obtaining stems of words in the article, a parallel version of the article wherein the stemmed words are translated from the foreign language into a known language, a module for requesting and receiving a translation of a word in the article and a module for generating and displaying a drill exercise prompting the user to assimilate the word.

The invention has many advantages. The highly personalized system for teaching or learning a foreign language is based on an interactive language system capable though its design and implementation of tracking individual dictionary development, of acquiring and classifying learning materials from internet and user' own sources according to the user's dictionary at any given point, of conducting tests that result in the change of the individuals' dictionaries or vocabularies, of facilitating interactive on-line and off-line contact between system users, and of providing a platform for building subject-specific dictionaries that can also benefit other users of the system.

More specifically, the invention provides a highly customized interactive method and system capable of acquiring, classifying and storing up to date reading materials which address a wide range of interests, cover specialized disciplines and which reflect the latest trends in idioms, word usage and other neologisms. To facilitate selection, the reading materials can be ranked in relation to each individual's level of proficiency in the foreign language. Interactive word translations and interactive drilling exercises for words encountered in the reading materials target individual needs and are presented on demand.

In specific aspects, the invention can track individual progress and monitor word usage and the evolution of individual active and passive vocabularies. Thus it can offer refresher exercises or drills targeting words that are not used or are used incorrectly.

The invention can be used to compare individual progress to that of an average student and to identify best performers. It allows storing user-specific information for any desired period, thus providing the opportunity for the language learners to “refresh” their skills based of their exact learning history, rather than re-learning the language based on generic learning materials.

Furthermore, the invention provides a platform for building subject-specific dictionaries that can benefit all users. The interactive dictionary-building functionality gives users the opportunity to post and vote for words currently not in the system dictionary and represents a unique tool for keeping up with evolution of the language and to expand existing dictionaries.

In some aspects, the invention can be used to promote online or offline networking and collaboration giving students an opportunity to discuss the materials they read and discuss them in the language they are trying to learn. In one aspect of the invention, the system may be used to identify students with similar interest/proficiency profiles in a given geographic area in order to facilitate face-to-face meeting needed to enrich the learning experience.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 illustrates an example of a centrally-hosted learning system accessible though the Internet or via off-line PDA or smart-phone devices.

FIG. 2 illustrates an example of data and document flow during acquisition of reading materials and text preprocessing.

FIG. 3 is a table showing an example of results that might be obtained using a community-voting mechanism employed to build and maintain an up-to-date multilingual global dictionary.

FIG. 4 illustrates an example of a user specific article classification and selection.

FIG. 5 shows a list of pre-selected articles categorized by subject and ranked, with respect to a specific user, by level of difficulty.

FIG. 6 shows the text of an article selected from the entries shown in the Sci/Tech section of FIG. 5 and entitled “Enterprises Slow to Dump IE”.

FIG. 7 illustrates a request for translation from the text shown in FIG. 6, and a popping up window displaying the translation.

FIG. 8 illustrates a reading comprehension process, including selection of target words for translation and further drill exercises.

FIG. 9 illustrates an example of a flash card including one correct choice and three incorrect alternatives.

FIG. 10 depicts an example of a flow of data and operational steps for a flash card drill.

FIG. 11 depicts an example of a flow of data and operational steps for a word substitute drill.

FIG. 12 shows a an excerpt of the “Enterprises Slow to Dump IE” in which a target word was blanked, together with a popped up window offering a user a selection of four words, one being the target word.

### DETAILED DESCRIPTION OF THE PREFERRED EMBODIMENTS

The invention generally relates to a method and system for teaching or, from a user's point of view, for learning a foreign language. Generally, a user is a person who wishes to study a foreign language, e.g., a student. In some aspects of the invention, the user also is a subscriber of the system described herein.

Practicing the invention does not depend on a particular architecture, apparatus, hardware or software platform. The system described herein can be implemented by any suitable combination of components and there may be several ways for realizing the educational system and method of the invention in the form of a computer-run application. While various types of general-purpose devices can be used, it is also possible to construct specialized apparatus to perform the method described herein or any steps thereof.

The system can be built in several ways. For example, it can be fully standalone, e.g., an autonomous desktop software installation, or it can be a Web based system that runs on a central server enabling users' access through the Internet. The system also can have intermediate characteristics, involving client-based implementation that will synchronize data with a central depository on a pre-defined basis. This particular architecture is useful for access in the absence of internet connections, for instance during commuting and can utilize personal digital assistants (PDAs), smart-phones, e-books, and other means.

Given the amount of pre-processing and relative repetitiveness of operations for all system users, networking functionality and requirements for storage of individual information in one place, often for a long period of time, building a system as an Internet-hosted application is particularly advantageous.

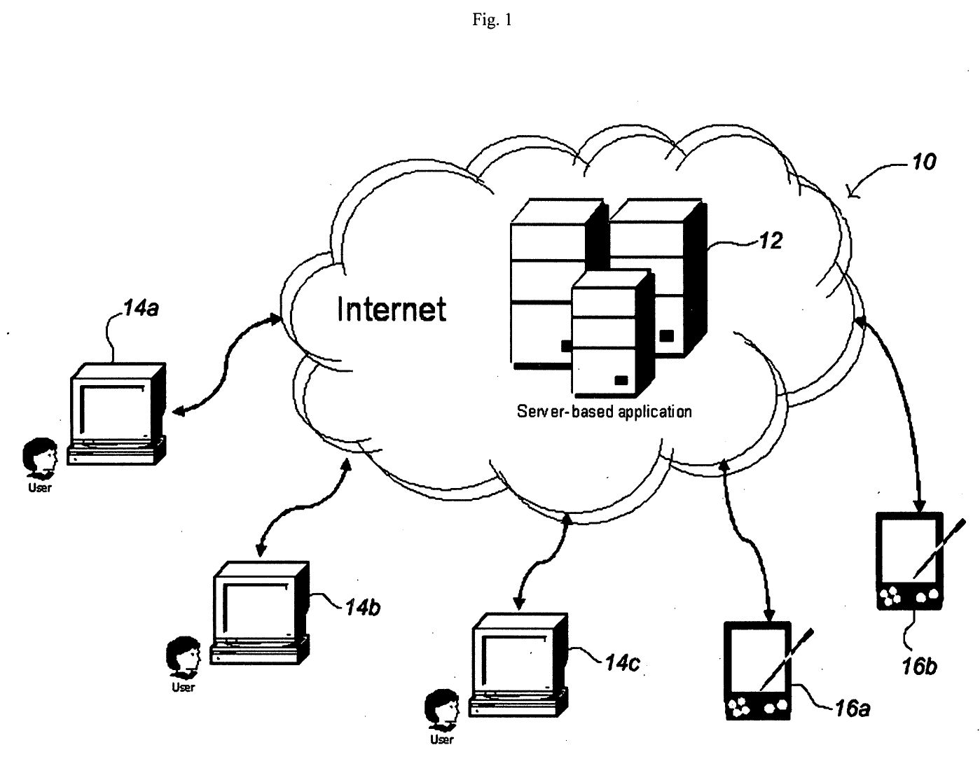

Preferably, the system supports several languages and can be accessed simultaneously by more than one user. In the example shown in FIG. 1, system 10 includes server-based application 12, accessible via the internet. Users can access the system and their personal information from personal computers 14a, 14b and 14c using a standard Internet browser. Off-line users can access the system via PDAs 16a and 16b or via smart-phones and may have to synchronize their locally stored data with small portions of the central data depository in order to build and track user-specific dictionary in one location.

A user can logon to the system via a logon code and/or password. In this embodiment, all individually customized information about the user is stored and updated centrally and users have an opportunity to use the system irrespectively of their physical location by means of a personal computer connected to the Internet or via a PDA, smart-phone, or another device.

Information associated with an individual user may include personal information, e.g., name and address, account information, identification of the user's native or known language, information regarding a target language that the user desires to study, the user's learning preferences, level of knowledge in the language, and other information. This information or any portions thereof can be stored in the system. In other examples, all or part of the user's information can be provided each time the user logs into the system.

A request for all or part of the user's information can be made every time the user logs on. Preferably, a user profile is stored and updated by the system and is automatically available upon recognition of the user's identification code. A stored user profile can be modified as needed, by the user and/or system administrators.

Also associated with an individual user is the user's personal vocabulary or personal dictionary in the foreign language. At a given point in time, the user's vocabulary can include words in an active vocabulary and words in a passive vocabulary.

Words in a user's “active vocabulary” are words known to the user. They are words whose meaning is correctly identified by the user; in addition, words in the “active vocabulary” are used by the user and are used correctly, as determined by the method described herein.

In contrast, words to which the user has been exposed but are not used, or are incorrectly used, as monitored by the method described herein, form a user's “passive vocabulary”. In specific examples, words in a user's passive vocabulary might be words that the user recognizes but has not yet filly assimilated. In other specific examples, words in the passive vocabulary are not even be recognized by the user; rather, they are identified by the system as words that the user had once known.

In preferred embodiments of the invention, a user's active vocabulary is assembled, stored and updated. In other preferred embodiments, a user's passive vocabulary also is assembled, stored and updated. Personalized word lists or vocabularies can be assembled and stored, for example, in one or more databases, and can be linked to an individual user by a user identification code or by other means known in the art.

Assembly of initial personal dictionaries can be performed at one time, for example when the user first subscribes to the system. One or more tests can be provided to determine an initial list of words recognized by the student. Initial personal dictionaries also can be assembled starting with the first reading comprehension by tracking words as they are recognized or not. As further discussed below, initial dictionaries change with the learning process.

Storing personal dictionaries can be via one or more databases, as known in the art.

To build up his or her personal dictionary, and in particular to enlarge an active vocabulary, the user has access to a collection of reading materials in the target language. From the collection, the user can select a particular reading material based on the user's preferences, interests, level of proficiency in the target language or other criteria, as further described below.

Preferably, a collection of reading materials is available for each language offered by the system. Reading materials in the collection can include texts in specialized fields or disciplines as well as articles, news, blog extracts, chats, transcripts and other general interest texts. They can be collected from the Internet, submitted by individual users, or in other ways. Preferably, the reading materials are up to date and reflect current trends in professional vocabularies, idioms, slang, new words, new meanings and new language patterns.

In a specific example, reading materials are collected via an RSS feed from multiple pre-determined web-sites in all supported languages. “RSS” refers to an internet format that provides quick and easy access to Web-based headlines, blurbs, article links, and other texts from a wide variety of sources, e.g., online newspapers, magazines, weblogs, blogs, technical information sites, etc. As used herein the “RSS” acronym stands for both “Really Simple Syndication” and “Rich Site Summary”.

Reading materials can be stored, for example, in one or more databases preferably residing on the system, for instance on a database server. Reading materials also can be stored on an external unit linked to the system so that users, system administrators, account representatives and other authorized personnel can access the reading materials via the internet, local area networks or other means.

Reading materials can be added, maintained and deleted according to gathering and/or retention protocols. Daily news, for instance, can be gathered daily or hourly, can be the subject of a short retention period and can be deleted within hours or days. Specialized articles, such as, for instance, a report on a clinical trial, can be retained in the collection for longer periods, e.g., weeks or months.

Once stored, a reading material preferably is processed by the system to convert words found in the reading materials to a normalized form. For example, conjugated verbs are normalized to their infinitive forms, declined nouns are normalized to the nominative singular form, and so forth.

This type of conversion is sometimes referred to as “stemming” and can be carried out by a stemming unit, or stemmer, using specialized software. Multi-language stemming software, for example, is available in the form of commercial or freeware product and often provides a set of rules that defines transformation of the words in multiple languages. Generally, stemming does not alter words that only have one form in the original language, for example, names of geographic locations, adverbs, articles and so on.

In most cases, existing commercial and freeware dictionaries are designed to translate stemmed words and may not recognize words in their non-normalized forms. The conversion to normalized words, therefore, facilitates translating words from the original language of the reading material, to other languages supported by the system.

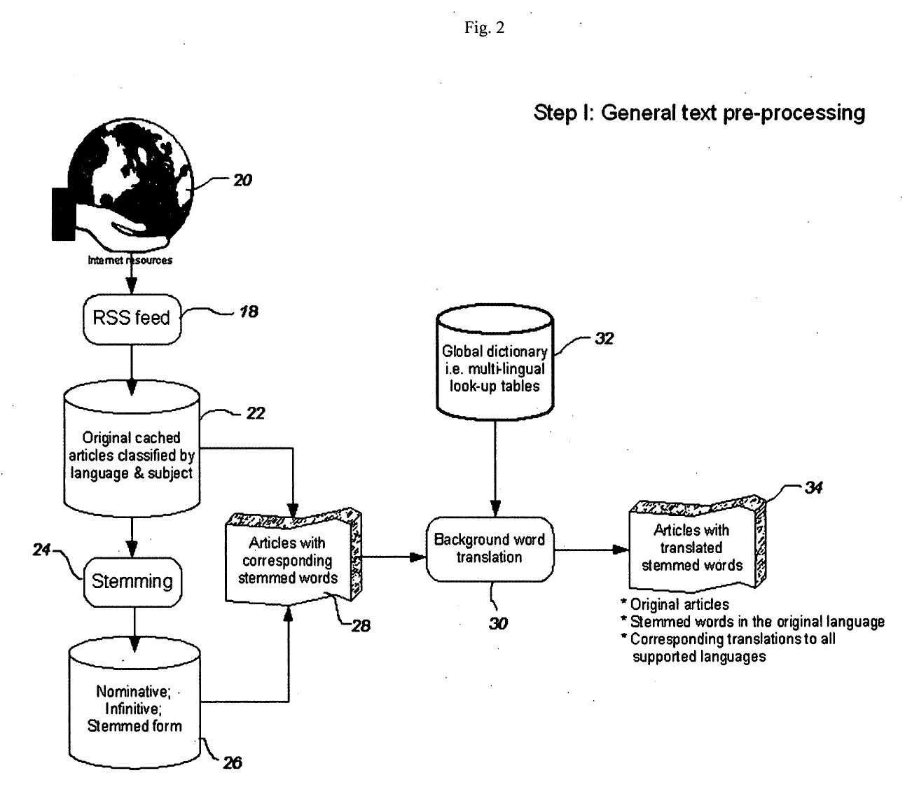

An example of operations related to gathering and pre-processing reading materials is illustrated in FIG. 2. As shown in FIG. 2 RSS feed 18 provides information from multiple pre-determined web-site sources 20 in all supported languages. This operation can be conducted on a pre-determined regular basis.

The retrieved articles, in their original language, are stored locally on database server 22 and classified by language and subject. Other or additional classification criteria such as, source, popularity, dates, word counts also can be used.

After the original cached reading materials 22 are stored, they are processed by a stemmer or normalizing unit 24, as discussed above, to convert article words to their normalized form 26. After normalization or stemming of its content words, a reading material in its original language preferably is appended with corresponding normalized words and stored as reading materials, e.g., articles, with corresponding stemmed words 28. Reading materials 22, stemmed words 26 and reading materials with corresponding stemmed words 28 can be stored in one or more databases.

Reading materials, e.g., articles, with corresponding stemmed words 28 are translated, resulting in a collection of reading materials with translated stemmed or normalized. The translation of the stemmed words can represent one-to-one or one-to-many relations established between stemmed words from the original text and their corresponding translation(s) to one, more, or all supported languages.

The translation function is provided by a translator 30 which provides background word translation to generate parallel versions of the original reading materials, in one, more than one or all languages supported by the system. In the parallel versions of the reading materials, the normalized words are translated from the original language into one, more than one or all supported languages. Translator 30 links words in the article, preferably stemmed as described above, with global dictionary 32. Upon the end of the translation, articles with translated stemmed words are stored in database 34. Database 34 preferably is assembled to include original reading materials, as initially retrieved and stored, normalized or stemmed words in the original language, as well as corresponding translations in one, more than one or all supported languages.

Global dictionary 32 preferably has multi-lingual look-up tables, which can reside on one or more databases. In one example, global dictionary 32 supports all languages offered by the system. In specific aspects of the invention, global dictionary 32 is updated and edited to reflect language and usage changes, to add new words or word meanings, and so forth.

In one example, words encountered in reading materials that are not found in the existing global dictionary are posted so that users can provide information regarding their meaning. This is particularly useful for building highly customized dictionaries for subject-oriented language learners, as even the most comprehensive and sophisticated dictionaries are not always capable of tracking industry-specific terminology, evolving slang, changes in word meaning and other neologisms.

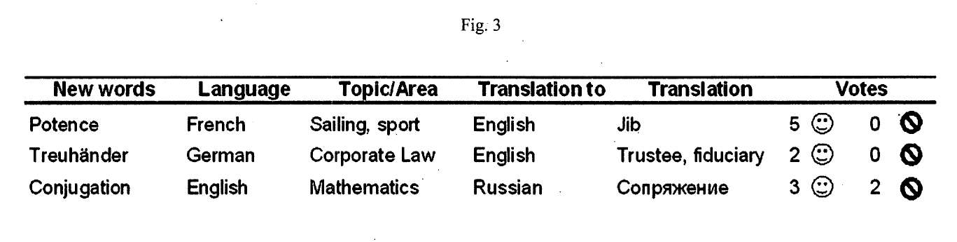

A collective dictionary building effort can be implemented, for instance, through a voting mechanism, as illustrated in the table in FIG. 3. Shown in the table in FIG. 3 are the results that might be obtained through user voting regarding the meaning of three words new to an existing global dictionary. The words, originally in French, German and English, are in three different fields. Each word has already received several votes.

Once the word is voted for by a sufficient number of system users, and/or a consensus regarding its meaning has been reached, it is added to the global system dictionary and becomes available for everyone during the reading comprehension, e.g., word look-up, and other sessions.

In other examples, dictionaries external to the system can be accessed via the internet, local area networks or by other communication links.

In preferred aspects of the invention, reading materials collected and pre-processed as described above, are ranked with respect to their complexity or difficulty. The ranking is specific to each individual user and is indicative of the overlap between the words in the reading material and the words in the user's personal vocabulary, for instance the percentage of words in the text known to a specific user.

To customize the ranking, the words in the reading material can be compared with the user's vocabulary in the foreign language to determine the intersection or overlap between the reading material and the student's vocabulary. This ranking can enable students to select reading materials, e.g., articles, according to their knowledge level, thus improving the efficiency of the learning session.

Preferably, the overlap considered is that with respect to a user's active vocabulary. In other embodiments, the ranking can be with respect to the user's passive vocabulary or with respect to both, the user's active as well as the user's passive vocabulary.

The greater the overlap between the words in a reading material and an individual user's vocabulary, the lesser difficulty or complexity is assigned to the reading material. On the other hand, reading materials that have little or no overlap with a user's personal dictionary, e.g., a user's entire vocabulary or a user's active vocabulary, are ranked to indicate a high degree of complexity or difficulty.

Customizing reading materials can further take into account additional factors. For example, it can take into account individual characteristics, such as a user's tolerance to new words. It also can take into account objective factors such as the statistical frequency of new words in the language as a whole.

The ranking can use a numerical or alphabet letter scale. In one example, a ranking of 1 through 100 is employed, with 100 indicating that the user will encounter the highest degree of difficulty reading the text. In other examples, the ranking can use descriptors such as “very easy”, “easy”, “moderately complex”, “difficult”, “extremely difficult” and others. Since the ranking is relative with respect to each user, the same article can be ranked as easy for one individual and as extremely difficult for another.

In other examples, the individually tailored ranking is based on pre-computed individual proficiency level, or other criteria.

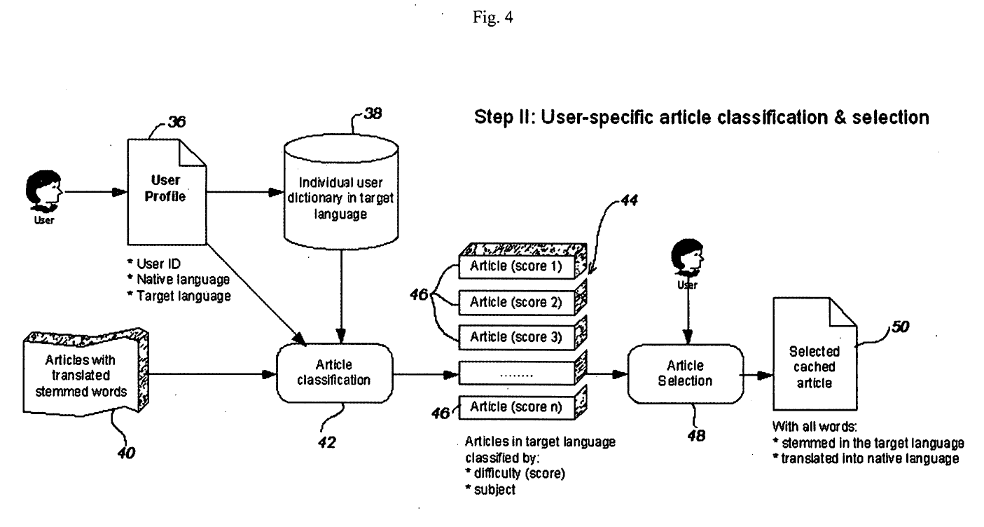

Article selection is user-specific. An example of a user specific article classification and selection, which utilizes the user's vocabulary, e.g., active or active and passive vocabularies, is shown in FIG. 4. Upon logging into the system, for instance via a logon identification code, the user in this example provides additional data for future informational processing such as, for instance, his/her native language and the target or foreign language that the user is studying. This information can be stored as user profile 36 and can be automatically accessed by the system on recognition of the user's identification (ID) code.

Associated with the user is individual user dictionary 38, which can include both the user's active and passive vocabulary in the target (foreign) language. Individual user dictionary 38, in the target language, is the personal dictionary that the user has built up to a given moment.

Based on the user-specific information, the system presents, from collection of reading materials 40, e.g., articles, those that are in the user's target language. Through classification function 42, the system classifies the reading materials and performs a comparison between user vocabulary of known words and the stemmed words from each reading material. Depending on the fit between these two sets, the system scores or classifies the articles from the most difficult (minimal intersection or overlap) to the simplest (maximum intersection or overlap).

If RSS feeds provide additional information about subject of the article, the system presents the user with a list of all stored articles in the user's target language classified by both subject and difficulty. Thus collection of classified articles 44 includes articles 46 in the user's target language, classified by a difficulty score and by subject.

The user has a choice to select an article from collection 44 for the learning session according to his or her personal preferences. Selection function 48 of a specific text from the collection can be menu driven, by key words searching, content domain or other means known in the art.

As discussed above, cached article 46, selected by the user, is appended with all words, stemmed in the target language which is also the original language of article 50 and the translation of the stemmed words from the target language to the user's native language.

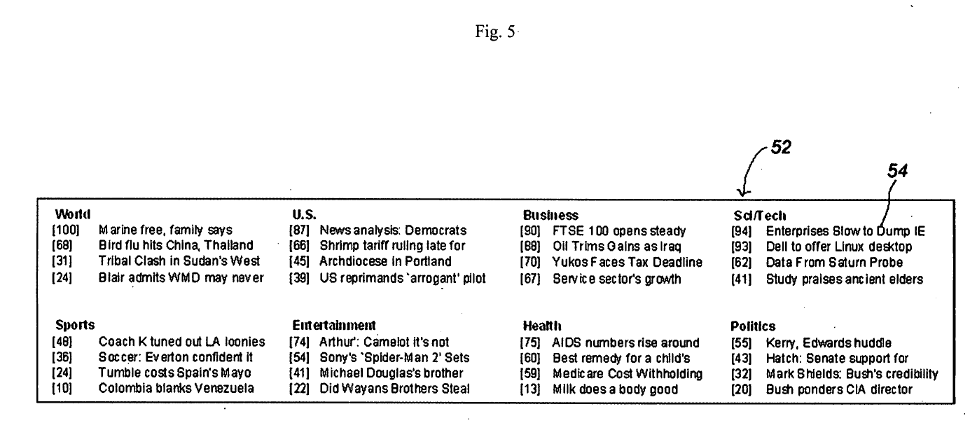

In one example, upon logging into the system and successful authentication, the user sees a menu showing a collection or list of pre-selected, categorized and ranked reading materials. An example of such a list, list 52, is shown in FIG. 5. The list of reading materials is that of reading materials offered to a French-speaking user, learning the English language. In this example, the user logged into the system on Jul. 6^{th} 2004 and the target articles cover major events that happened on July 6^{th}. Preferably, the reading materials are updated and different reading materials would be available on a different date, thus tracking news and events in real time.

As discussed above, the difficulty level, expressed in FIG. 5 on a scale of 0 to 100, is individual to the user and is defined by individual active and/or passive vocabulary lists tracked by the system.

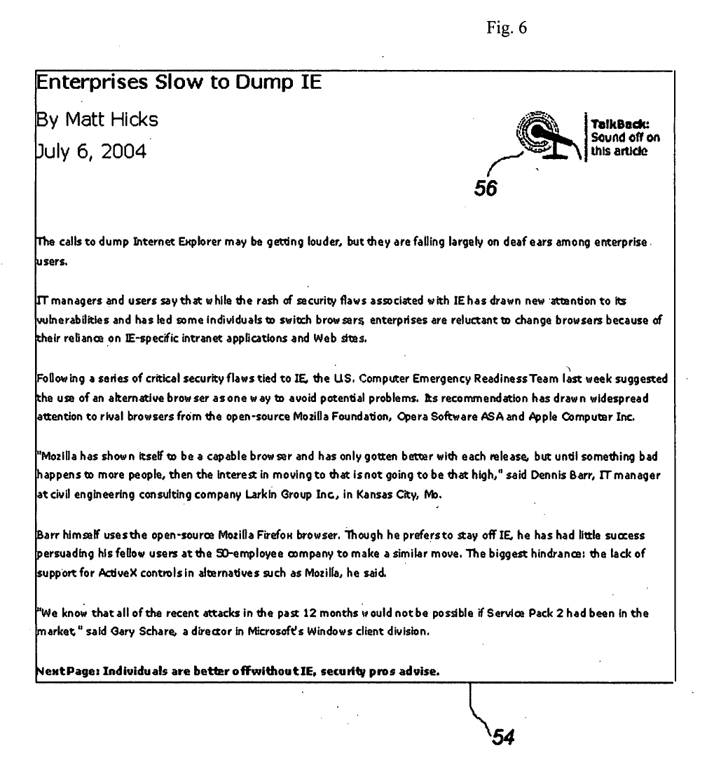

The French-speaking user can select a reading material from the list by a point and click method, voice recognition means or by other techniques known in the art, resulting in a display of the full-text of the reading material. As an example, the French-speaking user selects reading material 54 from the Sci/Tech category, specifically the article entitled “Enterprise Slow to Dump IE”. This reading material is ranked 94 and presents, to this particular user, the highest degree of difficulty in the Sci/Tech category. Upon selection, the system displays the full text of reading material 54, which is shown in FIG. 6.

As discussed above, the selected reading material is associated with the translation of all normalized words in the article. In a preferred aspect of the invention, corresponding normalized words and their translations are invisible to the user.

Icon 56 or other means for initiating or participating in a group discussion or chat session regarding the article also can be provided for each reading material, as indicated by the “talk back” icon linked to the article shown in FIG. 6. “Sounding off” on specific reading materials further enhances the learning process by allowing an individual user to discuss a reading material with other users and to discuss it in the target language, thus building up conversation and writing skills. In this aspect of the invention, the learning experience is enhanced as the system enables a collaborative functionality by letting students to discuss the articles they have read and practiced. By discussing a particular article, the students self-profile themselves on a proficiency and interest basis. The on-line forum dialogs around a well-known reading material can further accelerate learning process adding interactivity and group experience.

Once the user has selected a reading material from the provided list, he or she begins the session for vocabulary building. As the user reads the material, the student encounters known words. If the student identifies an unknown word, or a word that the student has forgotten, he or she can request a translation of the target word.

A communication link and/or interface is provided for requesting and receiving the translation of a targeted word. The user can request translation of the word by “point and click” techniques, by highlighting the word or by other means used in interactive environments. For example, during the reading comprehension session, the user can click at any word in the article to immediately get its translation to his or her native language. As discussed above, the selected cached article already has corresponding stemmed word and their translations in a separate hidden table, so the look-up process is fast and does not require on-the-fly computations. Look up functions are implemented as known in the art.

The translation can include all the meanings of the word. Among several meanings, the translation preferably identifies the specific meaning that the target word has within the context of the reading material. In some examples, the system can display the translation of the word from its original language into more than one or into all languages supported by the system.

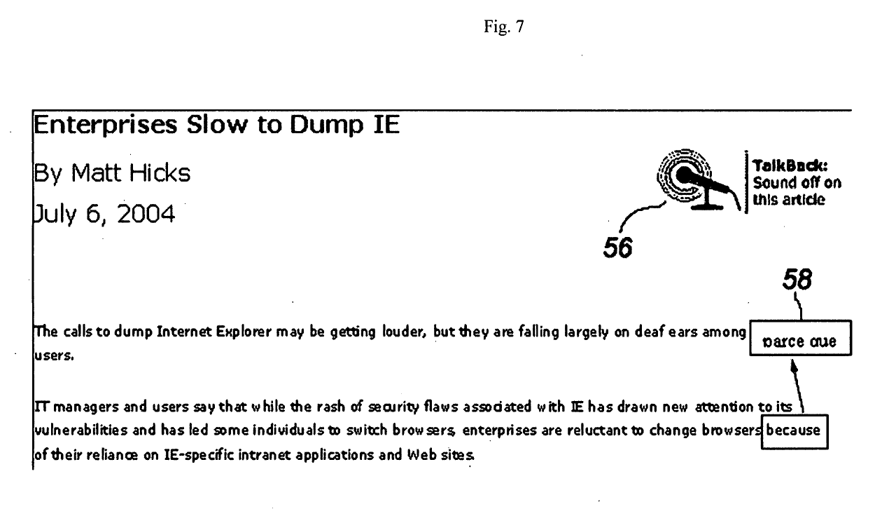

In the specific example of the French-speaking user who has selected the English article shown in FIG. 6, the request of a translation of a target word is illustrated in FIG. 7. As shown in FIG. 7, the user identified the word “because” and a translation for the target word, from its original language (English) to the native or known language associated with the user (French) is displayed by the system in “popped-up” window 58. Specifically, the translation of the word “because” into the user's native language, appears as the phrase “parce que”.

If the user encounters a word that he or she cannot translate with the help of the system, the user has an opportunity to present the word for the rest of the language learning community asking for help, as part of the dictionary building function discussed above. Once the translation is found and proven by multiple votes from the advanced learners or native speakers of a particular language, the word is fed into the global dictionary and becomes available for the whole user base of the system.

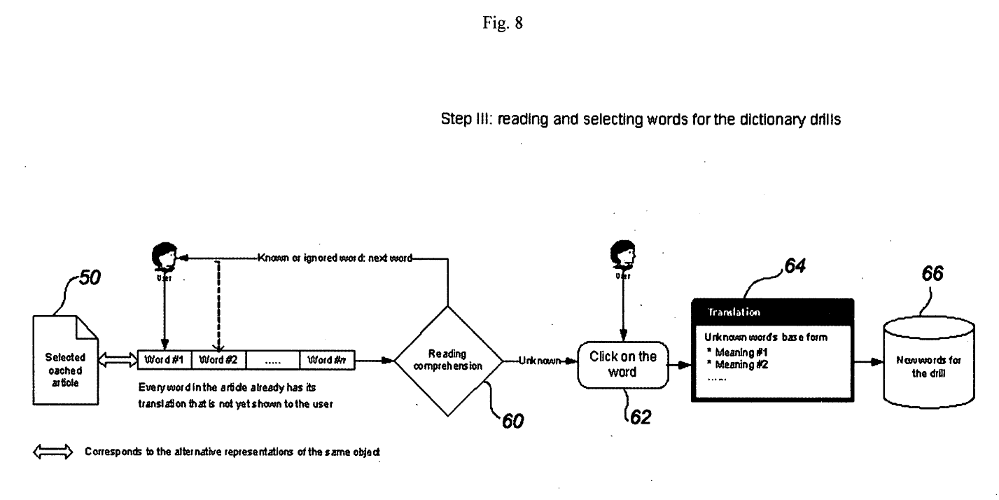

In a preferred embodiment, target words selected by the user are identified in the system as words for which further exercises can be presented to the user to promote or facilitate their assimilation. An example of an overall vocabulary building session, including reading of a selected material, requests for translations of unknown words and retention of new words for further drill exercises is shown in FIG. 8.

As shown in FIG. 8, selected cached article 50 includes word 1, word 2, . . . through word n in the original language of the article, which also is the target language for the individual user. Each word, preferably stemmed, in cached article 50 is associated with a translation from the target language into the native or known language of the user. In preferred aspects of the invention, translated words are invisible to the user until a target word is identified.

During reading comprehension exercise 60, the user skips over known or ignored words. Upon encountering an unknown word, the user clicks on the word via selection function 62. The system receives the request and displays translation 64. Translation 64 shows the unknown word's base form with meaning #1, meaning #2 and so forth. The unknown word may be sent to memorizing module 66 for drill exercises to promote, facilitate and/or test assimilation, e.g., memorization of the unknown word.

In preferred aspects of the invention, vocabulary building includes promoting and testing assimilation of a target word, for instance, by employing recognition and/or reproduction techniques and can be repeated at least once.

A recognition technique engages words both from the student's passive and active vocabulary by presenting the student with a) the target word along with multiple translations of the target word into the student's native language or b) providing the target-language context along with the target word as a part of some multiple-choice exercise where the target word can easily be guessed. The student is only required to recognize the target word and its meaning and will not necessarily be able to use the word in speech or writing.

A reproduction technique only engages the words from the student's active vocabulary by providing the student's native language translation alone or providing the target language context with the target word missing. Reproduction technique requires correct usage of the target word in both speech and writing.

Recognition

In specific examples, upon selecting a word in a reading material, the user is presented with one or more of a multiple choice type exercise, filling in the blanks type exercise, providing a substitute word type exercise, recognizing a synonym or an antonym, or another drill exercise.

Testing is evaluated to provide an evaluation outcome, e.g., to provide a measure of understanding or of assimilation of the word by the user. If, for instance, the user correctly responds to the tests, e.g., selects the correct choice and/or fills in the blank correctly, one or more times, the system considers the word known, understood or assimilated, the evaluation outcome results in adding the target word to the user's active vocabulary. Examples of a function for adding the assimilated word to the active vocabulary includes commercially available or customized software, such as for adding a new word to an exiting word list. The function may further perform a check of the existing vocabulary to avoid duplicate word entries.

The outcome of the evaluation also can indicate that the word is to be retained as unassimilated. More drill exercises can be presented to promote assimilation of the target word, upon which the word is added to the user's active vocabulary. In other examples, the word is added to the user's passive vocabulary and can be the subject of refresher drill exercises at a later time.

In a preferred embodiment, selection, e.g., a clicking, of a target word, indicates that the word is unknown to the user. A translation of the target word is displayed and the word is automatically sent to a module capable of generating one or more drill exercises designed to promote and test assimilation of the target word.

In the specific example of the French user reading the article “Enterprise Slow to Dump IE”, by clicking on the words “because”, the user sees its translation to French as “parce que”, as discussed with reference to FIG. 7. The same act of clicking also can send the word “because“ to a module, e.g., a memorizing module, for generating and displaying further drill exercises.

The module can include on or more units and can employ software designed to generate and/or display one or more drill exercises around each word. Commercially available or customized ware can be employed.

In a preferred example, a memorizing module is pre-populated by words from any given reading material. These words are individually specific as different students are reading different articles clicking on different words.

The memorizing module stores, or can generate interactively, drill exercises for each word. As a user selects a specific target word, the system displays drill exercises promoting or facilitating assimilation of the specific target word. Thus the words for which drill exercises are presented are specific to each individual user.

As different users read different materials, requesting translations of different words, the memorization module stores or is capable of interactively generating one or more drill exercises around each word targeted by the users. The memorizing module also is capable of directing the appropriate exercise to each user and preferably can perform multiple functions simultaneously.

Accessing drill exercises of new words also can be independent of the translation function discussed above. For instance, a user can independently request a translation of selected word and one or more drill exercises regarding the word. For example, by clicking on a target word, the system may provide the user with a menu, including, for instance, the options of: seeing a translation of the word; receiving one or more drill exercises; obtaining another reading material that includes the target word; and others.

A preferred method for memorizing a target word is based on flash cards. Flash cards can be in electronic or paper-form, using words from the texts read by a user. They can promote and/or facilitate memorization of unknown words, enhancing the user's active vocabulary.

Using the flash card approach, the user is presented with a sequence of words, each with several possible translations, e.g., a multiple choice type flash card. Several flash cards promoting memorization or recollection of a target word can be presented during a single learning session or over the course of several sessions. In further embodiments, the user also has an opportunity to repeat flash card drills related to words in one or more previously selected articles.

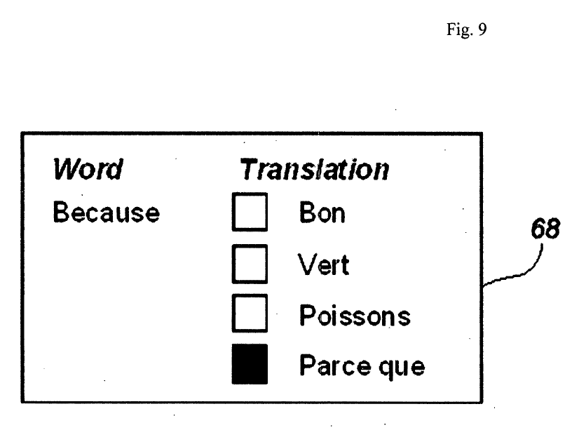

One example of a flash card that can be presented to the French-speaking student trying to assimilate, e.g., to memorize, the target word “because” is shown in FIG. 9. As shown in FIG. 9, flash card 68 shows several translation options, including the correct French translation “parce que”.

In one embodiment, the choices presented in the flash card or in other fill-in drills are selected from the user's passive vocabulary. And the user is given the opportunity to select the right translation choice for the word.

From the flash card choices, the user selects the translation that he or she considers most appropriate for the given word. If the translation is correct, once or several times in a row, the word becomes “known” and is added to the user's active vocabulary. This re-classification increases the user's individual usable dictionary and this enhancement, in turn, is taken into account for the next complexity ranking of reading materials.

If the student fails to answer correctly, this word will be retained as unassimilated, for instance until it becomes “known”.

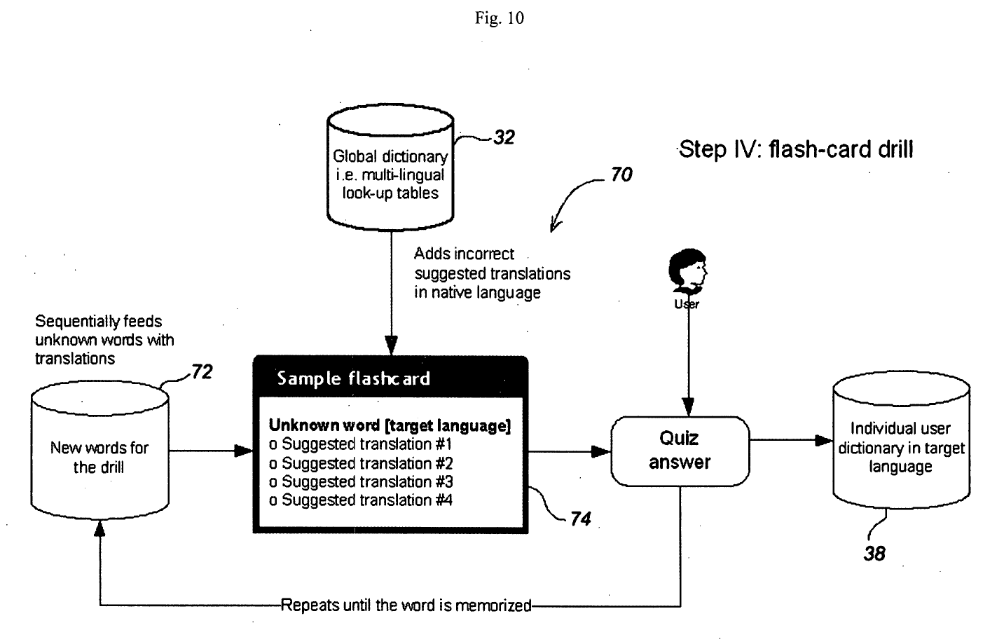

An example of informational flow for a memorizing module, which includes flash-card drill module 70, is shown on FIG. 10. In the example shown in FIG. 10, every flash-card drill session is based on target words that the user had selected from the original reading material. These can be compiled in list 72, which includes new words for the drill. List 72 can be stored, for instance, as a database or portion thereof.

In the course of the flash card session, the user is presented with randomly ordered sequences of unknown words from the original article with several alternative translations. Only one translation is correct. The other choices are taken from the main dictionary, preferably global dictionary 32, which has multi-lingual look-up tables. Preferably, the “wrong” alternatives are selected from global dictionary 32 in a manner that ensures that the suggested translations choices are not ambiguous. To eliminate ambiguity, the system might, for instance, determine if the set of translations for each option do or do not have common elements. The correct and incorrect choices are presented on flash card 74. Flash card 74 can identify the unknown word, in the target language, and present suggested translation #1, suggested translation #2, suggested translation #3 and suggested translation #4.

The word stays in the unknown category until the user correctly selects its translation within a certain number of attempts, or flash cards. While unassimilated, the target word is return to list 72 and is the subject of one or more additional flash cards.

Once the user has memorized the word, it goes into individual user dictionary 38, in the target language, preferably in the user's active vocabulary, to be utilized in the future article classification processes.

Another preferred method for memorizing and/or testing assimilation of the target word is based on the initial reading material and enables a student to practice his or her dictionary taking into account the context and usage pattern for the particular word.

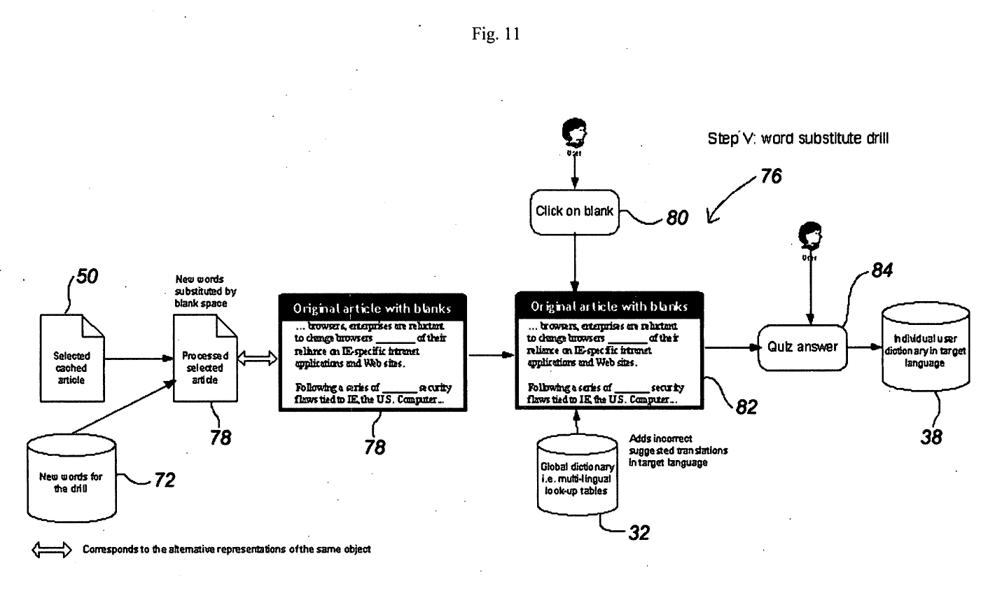

An example of informational flow using memorizing module that generates a contextual dictionary drill 76 is shown on FIG. 11. As shown in FIG. 11, target words identified by the user during the reading comprehension session are compiled in list 72, which includes new words for the drill. List 72 can be stored, for instance, as a database or portion thereof

Selected cached article 50 is processed, by substituting initially unknown words with blank spaces, generating processed article 78. The system remembers the original word and suggests it together with other options that are not appropriate in the given context. Incorrect choices are preferably obtained from global dictionary 32, which has multi-lingual look-up tables. In one embodiment, the incorrect choices are words from the user's active vocabulary, presented to the student as translations. For a correct response, the user needs to type in the correct spelling of the original word.

The user has an opportunity to click on a blank space via function 80 to see several possible alternatives, of which one is the original while the others are incorrect. The incorrect alternatives, from global dictionary 32 preferably are selected in such a way as to avoid ambiguity. For instance, the system determines if the set of translations for each option do or do not have common elements.

Article 82 can show the possible alternatives of a given blank space by a popping up window, by sequential screens each showing an alternative, or by other means known in the art. The user provides a quiz answer via function 84. If the user selects the word correctly, once or several times, the word is added to individual user dictionary 38, which is in target language. Preferably, the assimilated word is added to the user's active vocabulary. The resulting enhanced personal dictionary is then used during the users' next session to classify the articles in the target language by their complexity.

If the user misses, the word will be retained as unassimilated and can become the subject of further drill exercises, e.g., flash cards, quizzes, fill in blanks, synonyms or antonyms choices, etc.

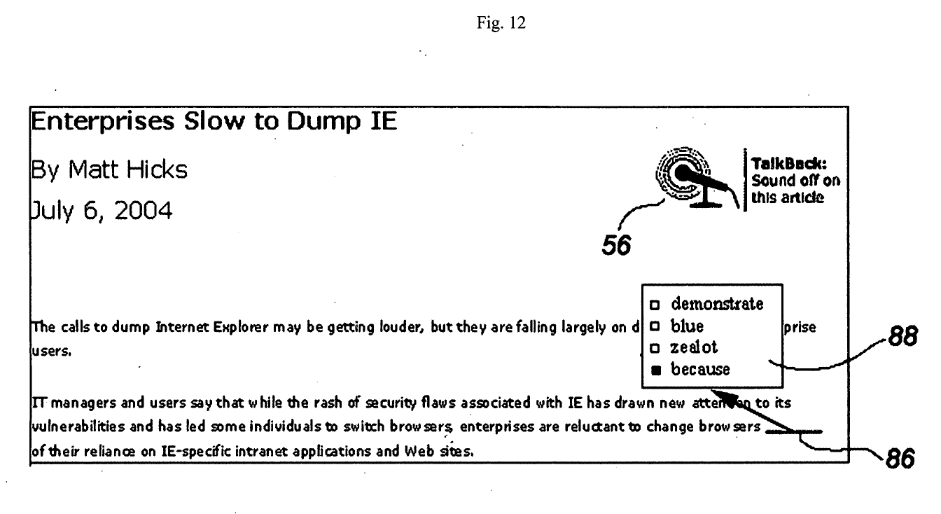

As illustrated on FIG. 12, the French user trying to assimilate the English word “because” has the option to fill in blank space 86 in the article “Enterprise Slow to Dump IE”. Several suggested choices, specifically “demonstrate”, “blue”, “zealot” and the original word “because” are shown in popping up window 88. If the user chooses the correct word, as it was used to be in the original document, this word becomes “known” and is added to the user's active vocabulary. Otherwise it is retained as unassimilated. Further exercises designed to promote or facilitate its assimilation can be presented during the same or in subsequent sessions.

As discussed above, addition of the target word to the user's active vocabulary affects rankings of reading materials available for future learning sessions. Failure to assimilate a new word and retention of the new word in a passive vocabulary associated with the user also affects future rankings of reading materials. A user word knowledge factor can be employed. The word knowledge factor changes with the addition of words to the user's passive vocabulary. Adding words to a user's passive vocabulary also can result in a reclassification or reconfiguration of the word in the user's learning profile.

Furthermore, a submission of a new word for a future drill, a memorizing session, e.g., with flashcards or a filling in blanks quiz, also can result in changes in the user's active and passive vocabularies therefore affecting future article ranking for the user.

Other memorization and testing techniques that can be employed include random quizzes regarding words in the passive vocabulary, selecting a synonym or an antonym or others. In preferred embodiments, users can select a favorite method for memorizing unknown words or for refresher exercises.

Memorization and testing techniques can be used alone or in combination. In a specific embodiment, memorization exercise based on flash cards is enhanced by context-specific word application drill.

In a specific example of the invention, the system performs an initial operation related to article gathering and text preprocessing (e.g., FIG. 2), followed by a user-specific article classification and article selection (e.g., FIG. 4). A step involving a user's reading and selection of target words (e.g., FIG. 8) is followed by at least one flash card drill (e.g., FIG. 10) and then by a word substitute drill (e.g., FIG. 1).

If a user does not use a word for a long period of time, he or she might entirely forget it. In preferred embodiments of the invention, usage of a target word added to the user's active vocabulary is monitored over a period of time, e.g., days, weeks or months.

Monitoring can be with respect to intensity and/or frequency of use, usage correctness, or other criteria. A generalized tracking protocol can be designed and implemented for all users. In preferred examples, individualized tracking protocols can be devised for each student and/or each word added to an active vocabulary. Individualized tracking protocols can take into account the frequency with which an individual user accesses the system, how the word is used by an average native speaker, whether it is a specialized or a general vocabulary word and/or other factors.

Monitoring can be implemented in the context of a reading comprehension session, for instance when the material selected by the student includes the word being monitored. Requesting the translation of the monitored word could indicate that it may not yet be fully assimilated by the user.

Monitoring can be conducted continuously throughout one or more sessions or intermittently, for instance by focusing only on specific reading material categories selected by the user and overlooking others. Such an intermittent approach may be appropriate when tracking usage of a specialized word, in the context of a specialized discipline. In such a case, sessions that involve reading materials that do relate to the specialized industry may be overlooked with respect to tracking usage of the specialized word.

If the word slips from the active vocabulary into the passive vocabulary, e.g., if the word is not recognized, is never used or is used incorrectly during the tracking period, drill exercises designed to refresh recollection and usage of the word preferably are presented to the user. Flash cards and other drill exercises, for instance such as those discussed above, can be employed.

Thus known words might be reclassified automatically into “unknown” words after a period of time and fed into the memorizing module for generating refresher exercises. By reclassifying and including the word into the drill module, the system ensures that previously learned words are not forgotten.

Correct completion of the drilling exercises results in transfer of the word back to the user's active vocabulary. Another period of tracking usage of the same word can follow.

In further embodiments, vocabulary-focused language learning is accomplished by additional functionalities targeting grammatical structures, listening comprehension, etc. These can be present in the form of separate modules or can be added to the core of the system.

In preferred embodiments, the user's overall foreign language proficiency also is updated. For instance, an overall proficiency can be increased with assimilation of new words into a user's active vocabulary or with the correct and frequent usage of newly added words.

The system can also be used for identifying students living nearby that have similar topical interest and/or proficiency levels. This can be accomplished using personal profiles stored in the system. In other examples, a unit or module is provided so that users can post information for forming student groups.

Once these students are known, the system can be used to co-ordinate face-to-face meetings of the previously individual language learners enriching their learning experience.

The present invention has been described in relation to particular examples, which are intended in all respects to be illustrative rather than restrictive. Those skilled in the art will appreciate that many different combinations of hardware, software, and firmware will be suitable for practicing the present invention.

Other implementations of the invention will be apparent to those skilled in the art from consideration of the specification and practice of the invention disclosed herein. It is intended that the specification and examples be considered as exemplary only, with a true scope and spirit of the invention being indicated by the following claims.

Thus while this invention has been particularly shown and described with references to preferred embodiments thereof, it will be understood by those skilled in the art that various changes in form and details may be made therein without departing from the scope of the invention encompassed by the appended claims.

What is claimed is:

1. An interactive method for teaching a foreign language, the method comprising:
a. displaying a translation of a target word selected by a user from a reading material;
b. testing the user's assimilation of the target word using a recognition or reproduction technique;
c. evaluating results of the testing to obtain a measure of understanding; and
d. adding the target word to an active vocabulary associated with the user or retaining the target word as unassimilated, depending on the measure of understanding.

2. The method of claim 1, further comprising providing the reading material.

3. The method of claim 1, wherein the reading material is selected by the user from a collection of reading materials.

4. The method of claim 1, wherein the reading material is ranked in its complexity by comparison with the user's active vocabulary in the foreign language.

5. The method of claim 1, further comprising repeating steps (b) and (c) at least once.

6. The method of claim 1, wherein testing the student's assimilation of the target word includes an exercise selected from the group consisting of a multiple choice exercise, a fill-in blanks exercise, a substitute word exercise, and any combination thereof.

7. The method of claim 1, further comprising facilitating assimilation of the target word by including the target word in at least one flash card.

8. The method of claim 1, wherein a meaning of the target word is reinforced by a contextual usage exercise.

9. The method of claim 1, further comprising updating the user's overall foreign language proficiency.

10. The method of claim 1, wherein the target word is normalized for matching with an entry in a global dictionary.

11. The method of claim 1, further comprising updating a global dictionary to include the target word.

12. The method of claim 1, further comprising providing the user with one or more potential study peers.

13. The method of claim 1, further comprising monitoring the user's usage of the target word.

14. The method of claim 13, wherein failure to accurately identify the target word during monitoring results in transferring said word from the user's active vocabulary to a passive vocabulary associated with the user and in a change in a word knowledge factor, said factor leading to further reclassification of the said word in a user's learning profile.

15. The method of claim 14, wherein words in the passive vocabulary are included in drill exercises presented to the user.

16. The method of claim 1, further comprising storing the user's active vocabulary.

17. The method of claim 1, further comprising assembling the user's active vocabulary.

18. A method for maintaining or increasing a user's proficiency in a foreign language, comprising:
a. storing a user's vocabulary in the foreign language;
b. monitoring the user's usage or recognition of words in the user's vocabulary to determine the user's active vocabulary and the user's passive vocabulary;
c. presenting the user with drill exercises for words in the user's passive vocabulary, thereby prompting the user to re-assimilate the words in the user's passive vocabulary; and
d. transferring re-assimilated words to the user's active vocabulary.

19. The method of claim 18, further comprising assembling the user's vocabulary.

20. The method of claim 18, further comprising presenting the student with new words and drill exercises for assimilating the new words into the student's vocabulary.

21. The method of claim 18, wherein the user's passive vocabulary includes words that monitoring determines the user uses infrequently, incorrectly or never uses.

22. The method of claim 18, wherein monitoring is ongoing or intermittent.

23. The method of claim 18, wherein the user's usage or recognition of the words is monitored by a reading comprehension exercise, a quiz, a fill in the blank exercise, a flash card exercise, or a reading material fill in exercise

24. The method of claim 18, further comprising maintaining a global dictionary, wherein words new to the global dictionary are posted for translation by users.

25. A method for customizing reading materials to a student's level of proficiency in a foreign language, the method comprising:
a. obtaining a collection of reading materials in the foreign language;
b. comparing the words in each reading material with a student's vocabulary in the foreign language, to obtain an overlap between each reading material and the student's vocabulary; and
c. ranking each reading material according to the overlap, wherein a higher overlap between the student's vocabulary and the reading material is indicative of a lower customized ranking in difficulty assigned to the reading material.

26. The method of claim 25, wherein the method factors in a statistical frequency with which a word new to the student occurs in the language.

27. The method of claim 25, wherein the method factors in a user's tolerance to new words.

28. The method of claim 25, wherein the collection of reading materials is updated periodically.

29. The method of claim 25, wherein the collection of reading materials is obtained by a RSS feed.

30. The method of claim 25, wherein reading materials in the collection are categorized by subject, date, source, topic, complexity, word count or any combination thereof.

31. A system for teaching a foreign language, the system comprising:
a. a translator linking words in a reading material to a global dictionary;
b. a communication link for requesting and receiving translation of a word in a reading material;
c. a module for generating and displaying a drill exercise using the word and for evaluating a user's response to the drill exercise; and
c. a function for adding an assimilated word to an active vocabulary associated with the user.

32. A system for teaching a foreign language, comprising:
a. a collection of reading materials in the foreign language;
b. a link for a user's selection of a reading material from the collection;
c. an interface for requesting and receiving a translation of a word in the reading material;
d. a module for generating at least one drill exercise to prompt assimilation of the word by the user; and
e. a module for adding an assimilated word to an active vocabulary associated with the user.

33. The system of claim 32, further comprising a link for building the collection.

34. The system of claim 32, further comprising a module for ranking the reading materials in the collection with respect to an overlap with the active vocabulary associated with the user.

35. The system of claim 32, wherein the word and the translation are included in a global dictionary.

36. The system of claim 32, further comprising a unit for monitoring the user's usage or recognition of the word.

37. The system of claim 32, further comprising a passive vocabulary associated with the user, the passive vocabulary including words recognized, but not yet fully assimilated by the user.

38. The system of claim 32, further comprising a unit for posting information for forming study groups.

39. The system of claim 32, further comprising a unit for posting translations to words new to the global dictionary.

40. The system of claim 32, further comprising a unit for stemming words in the reading materials and obtaining the translation of the stemmed words from the global dictionary.

41. A system for increasing a user's reading comprehension in a foreign language, comprising:
a. an article in the foreign language;
b. a stemming unit for obtaining stems of words in the article;
c. a parallel version of the article wherein the stemmed words are translated from the foreign language into a known language;
d. a module for requesting and receiving a translation of a word in the article; and
e. a module for generating and displaying a drill exercise prompting the user to assimilate the word.

42. An interactive method for increasing a vocabulary in a foreign language, the method comprising:
a. reading a text in the foreign language;
b. requesting a translation of an unknown word found in the text; and
c. responding to flash card exercises designed to prompt assimilation of the unknown word into the vocabulary.
